(19) United States
(12) Patent Application Publication
(10) Pub. No.: US 2025/0366500 A1
(43) Pub. Date: Dec. 4, 2025

(54) PHOSPHATES-FREE WATER HOLDING AGENT RICH IN AMINO ACIDS AND USE THEREOF IN EMULSIFIED MEAT PRODUCTS

(71) Applicant: Northeast Agricultural University, Harbin City (CN)

(72) Inventors: Qian LIU, Harbin City (CN); Chuan’ai CAO, Harbin City (CN); Baohua KONG, Harbin City (CN); Hui WANG, Harbin City (CN); Fangda SUN, Harbin City (CN); Meiyue LIU, Harbin City (CN); Honglei ZHAO, Harbin City (CN)

(21) Appl. No.: 18/927,173

(22) Filed: Oct. 25, 2024

(30) Foreign Application Priority Data
May 30, 2024 (CN) 202410688584.X

(51) Int. Cl. A23L 13/40; A23L 13/60

(52) U.S. Cl. CPC A23L 13/428; A23L 13/422; A23L 13/432; A23L 13/65

(57) ABSTRACT

A phosphates-free water holding agent rich in amino acids and use thereof in an emulsified meat product are provided, belonging to the technical field of food additives. The phosphates-free water holding agent includes a potassium salt, an amino acid, and a stabilizer, and can significantly improve water holding capacity and an emulsification stability of the emulsified meat product, improve texture characteristics of the emulsified meat product, and significantly reduce phosphates content. Therefore, the phosphates-free water holding agent improves a product quality and nutritional characteristics, and then meets the consumer's need for healthy consumption.

### CROSS-REFERENCE TO RELATED APPLICATION

This patent application claims the benefit and priority of Chinese Patent Application No. 202410688584X filed with the China National Intellectual Property Administration on May 30, 2024, the disclosure of which is incorporated by reference herein in its entirety as part of the present application.

### TECHNICAL FIELD

The present disclosure relates to the technical field of food additives, and in particular to a phosphates-free water holding agents rich in amino acids and its application in emulsified meat products.

### BACKGROUND

Emulsified meat products are prepared by chopping the muscle tissue and fat tissue of livestock and poultry at a low temperature, and then conducting processes such as stuffing and steaming. These products are popular among consumers due to their rich variety, unique flavor, and tender taste. Phosphates are widely used as a common food additive in the production of emulsified meat products. The phosphates can improve the water and oil holding capacity of a final product by increasing the pH value of a minced meat system and promoting the dissociation of actomyosin, while giving the product a desirable texture. In recent years, there is a widespread problem of excessive phosphate intake among consumers in today's society, which may lead to an imbalance in the calcium-phosphorus ratio, and then cause symptoms such as osteoporosis and tooth decay, thus posing potential harm to consumers' health.

With the continuous improvement of people's living standards and the popularization of healthy consumption concepts, products with a higher economic added value achieve excellent development prospects. At present, a large number of studies have shown that carbonates, alkaline amino acids, and cellulose exhibit a potential to replace the phosphates. However, the above substitutes alone cannot achieve an ideal replacement effect and to a certain extent have a negative impact on the quality of phosphate-free emulsified meat products. Meanwhile, some novel processing technologies (such as ultrasound, ultra-high pressure, and pulsed electric field) can significantly improve the quality of phosphate-free emulsified meat products, but still face many technical problems in their large-scale application in the meat industry. Therefore, it has become a problem and challenge for today's meat industry to develop a special compound phosphates-free water holding agent for emulsified meat products without affecting product quality.

### SUMMARY

In view of this, a purpose of the present disclosure is to provide a phosphates-free water holding agent rich in amino acids. The water holding agent is rich in amino acids and has an added value. After being added into the emulsified meat product, the phosphates-free water holding agent can significantly improve the water and oil holding capacity of the product. Moreover, the phosphates-free water holding agent can significantly reduce the phosphates content and give the product a desirable edible quality. The present disclosure avoids the problem that there is an extremely high phosphate content added into traditional emulsified meat products and simply reducing a dosage of the phosphate in a food formula can lead to product quality defects.

In order to achieve the above technical purpose, an objective of the present disclosure is to provide an amino acid phosphates-free water holding agent, including the following raw materials in parts by weight:
30 parts to 65 parts of potassium salt, 15 parts to 40 parts of amino acid, and 5 parts to 50 parts of cellulose stabilizer.

Preferably, the potassium salt is any one selected from the group consisting of potassium carbonate and potassium bicarbonate.

Preferably, the amino acid is any one selected from the group consisting of L-arginine and L-lysine.

Preferably, the cellulose stabilizer is any one selected from the group consisting of sodium carboxymethyl cellulose (Na-CMC) and cellulose.

Preferably, the Na-CMC has a degree of polymerization of 300 to 500.

Preferably, the cellulose is in a powder form and has a degree of polymerization of 500 to 600.

Another objective of the present disclosure is to provide a method for preparing an emulsified meat product using the phosphates-free water holding agent rich in amino acids, where the phosphates-free water holding agent is added into an emulsified meat product to be added, and the phosphates-free water holding agent accounts for 0.2% to 1.0% of a total weight of the emulsified meat product to be added.

Preferably, the emulsified meat product to be added is a frankfurter, and the frankfurter includes a main ingredient and an additive:
the main ingredient includes lean pork, pork back fat, and an ice-water mixture at a mass ratio of 2:1:1; and
the additive includes an edible salt, the phosphates-free water holding agent, sodium nitrite, a spice, monosodium glutamate, and sodium erythorbate.

Preferably, the additive includes the following components by weight percentage in the main ingredient:
1 wt. % to 2 wt. % of edible salt;
0.2 wt. % to 1 wt. % of phosphates-free water holding agent;
0.01 wt. % to 0.015 wt. % of sodium nitrite;
1 wt. % to 1.5 wt. % of spice;
0.05 wt. % to 0.1 wt. % of monosodium glutamate; and
0.1 wt. % to 0.15 wt. % of sodium erythorbate.

Compared with the prior art, the present disclosure has the following beneficial effects: an phosphates-free water holding agent rich in amino acids and use thereof in an emulsified meat product are provided. The phosphates-free water holding agent includes a potassium salt, an amino acid, and a stabilizer, and can significantly improve water holding capacity and an emulsification stability of the emulsified meat product, improve texture characteristics of the emulsified meat product, and significantly reduce phosphates content. Therefore, the phosphates-free water holding agent improves a product quality and nutritional characteristics, and then meets the consumer's need for healthy consumption.

### DETAILED DESCRIPTION OF THE EMBODIMENTS

The present disclosure is further described below with reference to examples. In the examples of the present disclosure, raw materials are all conventional commercially available products.

### Example 1

The phosphates-free water holding agent rich in amino acids included the following raw materials:
61 parts of potassium bicarbonate, 31 parts of L-lysine, and 8 parts of powdered cellulose (with a polymerization of degree of 500, the same below).

A frankfurter prepared using the phosphates-free water holding agent included the following raw materials:
1 kg of lean pork, 0.5 kg of pork back fat, and 0.5 kg of ice-water mixture; where based on a total weight of the main ingredient, an additive included: 1.5 wt. % of edible salt, 0.325 wt. % of the phosphates-free water holding agent, 0.01 wt. % of sodium nitrite, 1.15 wt. % of spice, 0.05 wt. % of monosodium glutamate, and 0.1 wt. % of sodium erythorbate.

A preparation method of the frankfurter included the following steps:
(1) fascia was removed from the lean pork, the lean pork was trimmed into small pieces, and the pork back fat and lean pork were pre-processed by mincing using a meat grinder with a mincer disc aperture of 3 mm;
(2) the lean pork, edible salt, phosphates-free water holding agent, sodium nitrite, and 50% of the ice-water mixture were chopped in a chopper for 3 min to 5 min, and then the spice and monosodium glutamate were added and chopped for 3 min to 5 min;
(3) the pork back fat and the remaining ice-water mixture were added to allow emulsification for 5 min;
(4) the sodium erythorbate was added to continue the chopping until a resulting sausage filler reached 12° C. to 14° C.; and
(5) the chopped minced meat was stuffed into sausage casings with a diameter of 18 mm using a sausage stuffer, dried, smoked, and steamed, and the resulting steamed sausages were quickly cooled, vacuum-packed, and refrigerated at 0° C. to 4° C.

### Example 2

The phosphates-free water holding agent rich in amino acids included the following raw materials:
47 parts of potassium bicarbonate, 24 parts of L-lysine, and 29 parts of powdered cellulose.

The frankfurter was prepared using the phosphates-free water holding agent, where other raw materials and the preparation method were the same as those in Example 1, and a dosage of the phosphates-free water holding agent added into the frankfurter was 0.425 wt. %.

### Example 3

The rich phosphates-free water holding agent rich in amino acids included the following raw materials:
38 parts of potassium bicarbonate, 19 parts of L-lysine, and 43 parts of powdered cellulose.

The frankfurter was prepared using the phosphates-free water holding agent, where other raw materials and the preparation method were the same as those in Example 1, and a dosage of the phosphates-free water holding agent added into the frankfurter was 0.525 wt. %.

### Comparative Example 1

Comparative Example 1 was based on Example 2, without adding the L-lysine and powdered cellulose, and the dosages of other additives remained unchanged.

### Comparative Example 2

Comparative Example 2 was based on Example 2, without adding the powdered cellulose, and the dosages of other additives remained unchanged.

### Example 4

The phosphates-free water holding agent rich in amino acids included the following raw materials:
55 parts of potassium carbonate, 36 parts of L-lysine, and 9 parts of Na-CMC (with a degree of polymerization of 500, the same below).

The frankfurter was prepared using the phosphates-free water holding agent, where raw materials and the preparation method were the same as those in Example 1, and a dosage of the phosphates-free water holding agent added into the frankfurter was 0.275 wt. %.

### Example 5

The phosphates-free water holding agent rich in amino acids included the following raw materials:
46 parts of potassium carbonate, 31 parts of L-arginine, and 23 parts of Na-CMC.

The frankfurter was prepared using the phosphates-free water holding agent, where raw materials and the preparation method were the same as those in Example 4, and a dosage of the phosphates-free water holding agent added into the frankfurter was 0.325 wt. %.

### Example 6

The phosphates-free water holding agent rich in amino acids included the following raw materials:
35 parts of potassium carbonate, 24 parts of L-arginine, and 41 parts of Na-CMC.

The frankfurter was prepared using the phosphates-free water holding agent, where raw materials and the preparation method were the same as those in Example 4, and a dosage of the phosphates-free water holding agent added into the frankfurter was 0.425 wt. %.

### Comparative Example 3

Comparative Example 3 was based on Example 5, without adding the L-arginine and Na-CMC, and the dosages of other additives remained unchanged.

### Comparative Example 4

Comparative Example 4 was based on Example 5, without adding the Na-CMC, and the dosages of other additives remained unchanged.

A group without the water holding agent added was used as a blank group; and a group with 0.4 wt. % of a composite phosphate added (sodium tripolyphosphate: sodium hexametaphosphate: sodium pyrophosphate in a compounding mass ratio of 1:1:1) was used a control group. The frankfurters prepared in the above examples and comparative examples were tested in the following specific methods:

### 1. Cooking Loss Rate and Emulsion Stability Test

35 g of raw minced meat was weighed into a centrifuge tube using an analytical balance and centrifuged at 3,500 r/min at 4° C. for 5 min. After centrifugation, the centrifuge tube was heated in a constant-temperature water bath at 75° C. for 30 min. After water bathing, the centrifuge tube was placed upside down at room temperature for 1 h to allow the liquid to flow into a glass dish.

The liquid in the glass dish was placed in an oven at 105° C. and heated to a constant weight. The water loss was a weight lost after the cooking loss liquid was dried, and the fat loss was a remaining mass after the cooking loss liquid was dried. The calculation formulas were shown in Formulas (1) to (3):

$$Cooking loss rate ( \% ) = \frac{Mass before heating ( g ) - Mass after heating ( g )}{Mass before heating ( g )} \times 100 ; \qquad Formula ( I )$$

$$Water loss rate = \frac{Water loss by heating ( g )}{Mass of raw minced meat ( g )} \times 100 ; \qquad Formula ( 2 )$$

$$Fat loss rate = \frac{Remaining mass after heating ( g )}{Mass of raw minced meat ( g )} \times 100. \qquad Formula ( 3 )$$

### 2. Texture Test

The test was conducted using a TA-TX plusC texture analyzer—double deformation compression mode. The test parameters included: pre-test speed of 1.5 mm/s, test speed of 1.5 mm/s, post-test speed of 10 mm/s, trigger force of 15 g, and probe model of P/2.

### 3. Phosphate Content

The phosphate content was calculated using an electron coupled plasma mass spectrometer, as shown in Formula (4):

$$Phosphate content ( mg / kg ) = \frac{( ρ - {ρ}_{0} ) \times V \times n}{m \times 100 \times 3.066} ; \qquad Formula ( 4 )$$

where
ρ represented a mass concentration of the element to be tested in the sample solution/(μg/L); ρ₀ represented a mass concentration of the element to be tested in the sample blank solution/(μg/L); V represented a fixed volume of the sample solution/mL; n represented a sample dilution factor; m represented a sample mass/g; 1000 represented a conversion factor; and 3.066 represented a coefficient of phosphate converted into total phosphorus.

The comparison results of the cooking loss rate and the emulsification stability of the products of Examples 1 to 3 and Comparative Examples 1 to 2are shown in Table 1:

TABLE 1

| | | Emulsification stability | |
|---|---|---|---|
| | Cooking Loss | Water loss | Fat loss |
| Item | rate (%) | rate (%) | rate (%) |
| Blank group | 12.44 ± 0.22a | 10.00 ± 0.14a | 0.78 ± 0.04a |
| Control group | 4.96 ± 0.09c | 3.22 ± 0.10c | 0.32 ± 0.02c |
| Example 1 | 4.70 ± 0.04cd | 2.80 ± 0.11d | 0.27 ± 0.02cd |
| Example 2 | 4.53 ± 0.23d | 2.40 ± 0.07e | 0.26 ± 0.02d |
| Example 3 | 4.40 ± 0.05d | 2.36 ± 0.04e | 0.25 ± 0.01d |
| Comparative | 7.62 ± 0.13b | 5.36 ± 0.16b | 0.45 ± 0.03b |
| Example 1 | | | |
| Comparative | 4.98 ± 0.14c | 3.35 ± 0.06c | 0.32 ± 0.02c |
| Example 2 | | | |

NOTE:
the data in Table 1 were expressed as mean ± standard deviation, and different letters in the same column indicated significant differences (P < 0.05).

The texture indicators of the products of Examples 1 to 3 and Comparative Examples 1 to 2 are shown in Table 2:

TABLE 2

| Item | Hardness/g | Elasticity/g | Chewiness/g · sec | Compactness/g · sec |
|---|---|---|---|---|
| Blank group | 61.71 ± 1.27a | 60.20 ± 0.59a | 762.63 ± 30.30c | 22.20 ± 1.42c |
| Control group | 51.95 ± 0.96c | 63.74 ± 0.64a | 917.72 ± 27.91bc | 27.08 ± 0.98ab |
| Example 1 | 56.41 ± 1.12b | 62.13 ± 0.42b | 897.16 ± 44.70a | 25.57 ± 1.02b |
| Example 2 | 56.90 ± 0.55b | 63.31 ± 0.44ab | 925.34 ± 38.95a | 28.31 ± 1.54a |
| Example 3 | 53.84 ± 1.36c | 63.09 ± 0.49ab | 795.95 ± 38.95bc | 25.36 ± 0.88b |
| Comparative Example 1 | 53.54 ± 1.06c | 62.08 ± 0.89b | 876.87 ± 23.01a | 24.82 ± 0.25bc |
| Comparative Example 2 | 52.00 ± 0.39c | 62.90 ± 0.44ab | 865.49 ± 18.03ab | 25.89 ± 0.16ab |

NOTE:
the data in Table 2 were expressed as mean ± standard deviation, and different letters in the same column indicated significant differences (P < 0.05).

The phosphate contents of the products of Examples 1 to 3 and Comparative Examples 1 to 2 are shown in Table 3:

TABLE 3

| Item | Phosphate content (mg/kg) |
|---|---|
| Blank group | 335.52 ± 3.39b |
| Control group | 656.92 ± 3.85a |
| Example 1 | 337.74 ± 3.71b |
| Example 2 | 340.54 ± 4.04b |
| Example 3 | 335.26 ± 1.68b |
| Comparative Example 1 | 335.37 ± 1.44b |
| Comparative Example 2 | 337.48 ± 4.13b |

NOTE:
the data in Table 3 were expressed as mean ± standard deviation, and different letters in the same column indicated significant differences (P < 0.05).

As shown in Tables 1 to 3, the cooking loss, water loss, and fat loss of the products in the example groups were significantly reduced compared with those in the blank group (P<0.05), and the texture characteristics such as elasticity and density were significantly improved. In addition, the phosphates contents of the examples were significantly lower than those of the control group (P<0.05). Therefore, the phosphates-free water holding agent could effectively improve the quality of emulsified meat product.

From the data of Example 2 and Comparative Example 1, it was seen that the cooking loss of Comparative Example 1 was significantly increased (P<0.05), the emulsification stability was significantly reduced (P<0.05), and the density of the emulsified meat product was significantly reduced (P<0.05). This confirmed that L-lysine had a strong alkalinity that could induce the unfolding of myosin, increase the solubility of myofibrillar protein, and improve the water holding capacity of the product. In addition, the results also showed that powdered cellulose could be emulsified with proteins and lipids in meat and bound in a three-dimensional protein network in the form of fillers or copolymers to form a uniform and dense gel network, thereby improving the water and oil holding capacity of products and improving the product texture.

The results of Comparative Example 2 and Example 2 showed that the cooking loss of Comparative Example 2 was significantly increased (P<0.05), the emulsification stability was significantly reduced (P<0.05), and the density of the emulsified meat product was significantly reduced (P<0.05). This suggested that powdered cellulose could be adsorbed on an oil-water interface, forming a spatial barrier around the emulsion droplets, reducing the interfacial tension and preventing droplet coalescence, thereby affecting the gel properties, emulsification properties, and water retention of products.

In Examples 1 to 3, potassium bicarbonate increased the electrostatic repulsion by increasing a pH value of the minced meat system, which was beneficial to the close binding among water, protein, and fat to form a dense and uniform three-dimensional network gel structure, thereby significantly improving the water retention capacity and emulsification stability of the product. L-lysine, as a basic amino acid that could not be synthesized by human body, could enhance the thermal stability of myosin, thereby promoting a smoother, more uniform, and denser surface of the product. At the same time, L-lysine could also play a synergistic role at low K concentrations, increase the solubility of myosin, and improve the water holding capacity of the heat-induced gel of meat protein. The powdered cellulose could interact with the proteins and lipids in the meat product to form emulsified droplets, which were bound in the three-dimensional network structure of the protein in the form of copolymers or fillers. This mechanism was conducive to improving the thermal stability of the protein and the gel strength of the system, and significantly improving the quality of the product.

The comparison results of the cooking loss rate and the emulsification stability of the products of Examples 4 to 6 and Comparative Examples 3 to 4 are shown in Table 4.

TABLE 4

| | | Emulsification stability | |
|---|---|---|---|
| | Cooking Loss | Water loss | Fat loss |
| Item | rate (%) | rate (%) | rate (%) |
| Blank group | 12.44 ± 0.22a | 10.00 ± 0.14a | 0.78 ± 0.04a |
| Control group | 4.96 ± 0.09d | 3.22 ± 0.10d | 0.32 ± 0.02c |
| Example 4 | 4.55 ± 0.17e | 3.23 ± 0.22d | 0.24 ± 0.01d |
| Example 5 | 4.73 ± 0.11de | 3.57 ± 0.23cd | 0.24 ± 0.02d |
| Example 6 | 5.35 ± 0.13c | 3.90 ± 0.19c | 0.24 ± 0.02d |
| Comparative | 6.64 ± 0.15b | 5.56 ± 0.26b | 0.37 ± 0.04b |
| Example 3 | | | |
| Comparative | 4.57 ± 0.13e | 3.27 ± 0.23d | 0.24 ± 0.02d |
| Example 4 | | | |

NOTE:
the data in Table 4 were expressed as mean ± standard deviation, and different letters in the same column indicated significant differences (P < 0.05).

The texture indicators of the products of Examples 4 to 6 and Comparative Examples 3 to 4 are shown in Table 5:

TABLE 5

| Item | Hardness/g | Elasticity/g | Chewiness/g · sec | Compactness/g · sec |
|---|---|---|---|---|
| Blank group | 61.71 ± 1.27a | 60.20 ± 0.59c | 762.63 ± 30.30c | 22.20 ± 1.42d |
| Control group | 51.95 ± 0.96e | 63.74 ± 0.64a | 917.72 ± 27.91a | 27.08 ± 0.98ab |
| Example 1 | 53.84 ± 0.90cd | 62.47 ± 0.59b | 871.05 ± 23.00b | 25.43 ± 0.61bc |
| Example 2 | 54.88 ± 0.26c | 63.60 ± 0.48a | 867.54 ± 11.55b | 27.98 ± 0.81a |
| Example 3 | 57.37 ± 1.45b | 60.83 ± 0.60c | 787.49 ± 15.38c | 25.72 ± 0.64bc |
| Comparative Example 1 | 52.41 ± 0.37de | 62.88 ± 0.26ab | 863.55 ± 5.48b | 26.35 ± 0.87abc |
| Comparative Example 2 | 52.93 ± 0.68de | 62.42 ± 0.19b | 867.40 ± 9.73b | 24.67 ± 0.97c |

NOTE:
the data in Table 5 were expressed as mean ± standard deviation, and different letters in the same column indicated significant differences (P < 0.05).

The phosphate contents of the products of Examples 4 to 6 and Comparative Examples 3 to 4 are shown in Table 6:

TABLE 6

| Item | Phosphate content (mg/kg) |
|---|---|
| Blank group | 335.52 ± 3.39b |
| Control group | 656.92 ± 3.85a |
| Example 1 | 335.65 ± 2.87b |
| Example 2 | 334.15 ± 4.18b |
| Example 3 | 334.94 ± 3.37b |
| Comparative Example 1 | 335.84 ± 2.79b |
| Comparative Example 2 | 336.69 ± 3.36b |

NOTE:
the data in Table 6 were expressed as mean ± standard deviation, and different letters in the same column indicated significant differences (P < 0.05).

As shown in the experimental data in Tables 4 to 6, the various indicators of Examples 4 to 6 were compared with the basic indicators of the blank group and the control group. The cooking loss, water loss, and fat loss of the products in the example groups were significantly reduced compared with those in the blank group (P<0.05), and the texture characteristics such as elasticity and density were significantly improved (P<0.05). In addition, the phosphates contents of the examples were significantly lower than those of the control group (P<0.05). Therefore, the phosphates-free water holding agent could effectively improve the quality of emulsified meat product.

From the data of Example 5 and Comparative Example, it was seen that the cooking loss of Comparative Example 3 was significantly increased (P<0.05), the emulsification stability was significantly reduced (P<0.05), and the density of the emulsified meat product was significantly reduced (P<0.05). This confirmed that L-arginine enhanced the solubility of myosin by increasing pH value, which was beneficial to improving the water holding capacity of the product. In addition, it was also confirmed that Na-CMC contained a large number of hydrophilic groups: —OH and —COONa. The appropriate amount of Na-CMC could be used as a thickener and stabilizer to improve a protein gel network structure, thereby giving the product excellent texture.

The results of Example 5 and the comparative example showed that the differences in cooking loss rate, water loss rate, and fat loss rate of Comparative Example 5 were not significant (P>0.05), and the density was significantly increased (P<0.05). This indicated that the Na-CMC had no significant effect on the water holding capacity of the product, but could be used as a thickener to improve the texture quality of meat products.

In Examples 4 to 6, potassium carbonate increased the electrostatic repulsion between proteins by increasing the pH value of the minced meat system, which was conducive to the close binding among water, protein, and fat to form a dense and uniform three-dimensional network gel structure, thereby significantly improving the water retention capacity and emulsification stability of the product. L-arginine, as an alkaline semi-essential a-amino acid in the human body with an isoelectric point of about 10.76, could enhance the solubility of myosin and improve the water retention capacity of the product. At the same time, L-arginine could work synergistically with a low K⁺ concentration to improve the thermally induced gel stability of meat protein and give the product excellent texture quality; the Na-CMC contained a large number of hydrophilic groups: —OH and —COONa. The appropriate amount of Na-CMC could be used as a thickener and stabilizer to improve a protein gel network structure, thereby giving the product excellent texture.

The above description is merely preferred implementation of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A phosphates-free water holding agent rich in amino acids, comprising the following raw materials in parts by weight:
30 parts to 65 parts of potassium salt, 15 parts to 40 parts of amino acid, and 5 parts to 50 parts of cellulose stabilizer.

2. The phosphates-free water holding agent rich in amino acids according to claim 1, wherein the potassium salt is any one selected from the group consisting of potassium carbonate and potassium bicarbonate.

3. The phosphates-free water holding agent rich in amino acids according to claim 1, wherein the amino acid is any one selected from the group consisting of L-arginine and L-lysine.

4. The phosphates-free water holding agent rich in amino acids according to claim 1, wherein the cellulose stabilizer is any one selected from the group consisting of sodium carboxymethyl cellulose (Na-CMC) and cellulose.

5. The phosphates-free water holding agent rich in amino acids according to claim 4, wherein the Na-CMC has a degree of polymerization of 300 to 500.

6. The phosphates-free water holding agent rich in amino acids according to claim 4, wherein the cellulose is in a powder form and has a degree of polymerization of 500 to 600.

7. A method for preparing an emulsified meat product using the phosphates-free water holding agent rich in amino acids according to claim 1, wherein the phosphates-free water holding agent is added into the emulsified meat product to be added, and the phosphates-free water holding agent accounts for 0.2% to 1.0% of a total weight of the emulsified meat product to be added.

8. The method according to claim 7, wherein the emulsified meat product to be added is a frankfurter, and the frankfurter comprises a main ingredient and an additive, wherein:
the main ingredient comprises lean pork, pork back fat, and an ice-water mixture at a mass ratio of 2:1:1; and
the additive comprises an edible salt, the phosphates-free water holding agent, sodium nitrite, a spice, monosodium glutamate, and sodium erythorbate.

9. The method according to claim 8, wherein the additive comprises the following components by weight percentage in the main ingredient:
1 wt. % to 2 wt. % of edible salt;
0.2 wt. % to 1 wt. % of phosphates-free water holding agent;
0.01 wt. % to 0.015 wt. % of sodium nitrite;
1 wt. % to 1.5 wt. % of spice;
0.05 wt. % to 0.1 wt. % of monosodium glutamate; and
0.1 wt. % to 0.15 wt. % of sodium erythorbate.
